(19) United States
(12) Patent Application Publication
(10) Pub. No.: US 2014/0279613 A1
(43) Pub. Date: Sep. 18, 2014

(54) DETECTING COUNTERFEIT ITEMS

(71) Applicants: VERIZON NEW JERSEY INC., Newark, NJ (US); VERIZON PATENT AND LICENSING, INC., Basking Ridge, NJ (US)

(72) Inventors: Woo Beum LEE, Basking Ridge, NJ (US); Michelle Felt, Randolph, NJ (US); Jeffrey M. Walsh, Verona, NJ (US)

(73) Assignees: VERIZON PATENT AND LICENSING, INC., Basking Ridge, NJ (US); VERIZON NEW JERSEY INC., Newark, NJ (US)

(21) Appl. No.: 13/828,631

(22) Filed: Mar. 14, 2013

(51) Int. Cl. G06Q 30/00

(52) U.S. Cl. CPC G06Q 30/0185
USPC 705/318

(57) ABSTRACT

A device may receive a request, from a user, to determine whether an item is a counterfeit item. The device may perform, based on receiving the request, a comparison of at least one of: one or more images of one or more first portions of the item to one or more images of corresponding one or more first portions of the authentic item that corresponds to the item, or one or more sounds of one or more second portions of the item to one or more sounds of corresponding one or more second portions of the authentic item. The device may determine whether the item is a counterfeit item based on performing the comparison. The device may provide, to the user and based on determining whether the item is a counterfeit item, information indicating whether the item is a counterfeit item.

### BACKGROUND

An individual may purchase items at various locations. Some of the items may be counterfeit items while other items may be authentic items. The purchasing experience may, therefore, become undesirable due to the uncertainty of the authenticity of the items being purchased.

### BRIEF DESCRIPTION OF DRAWINGS

FIG. 1 is a diagram of an overview of an implementation described herein;

FIG. 2 is a diagram of an example environment in which systems and/or methods described herein may be implemented;

FIG. 3 is a diagram of example components of one or more devices of FIG. 2;

FIG. 4 is a diagram of an example data structure;

FIG. 5 is a flow chart of an example process for configuring a user device;

FIG. 6 is a diagram of an example user interface for configuring a user device;

FIG. 7 is a flow chart of an example process for determining whether an item is a counterfeit item; and

FIG. 8A-8H are diagrams of an example of the process described in FIG. 7.

### DETAILED DESCRIPTION OF PREFERRED EMBODIMENTS

The following detailed description refers to the accompanying drawings. The same reference numbers in different drawings may identify the same or similar elements.

Systems and/or methods described herein may assist a user of a user device in detecting counterfeit items when purchasing the items and/or after purchasing the items. An item, as used herein, may include any consumer good that may be counterfeited.

FIG. 1 is a diagram of an overview of an implementation described herein. In FIG. 1, assume, for example, that a user is in the process of purchasing a handbag. Assume that the user has downloaded, onto a user device (displayed as a phone), an application to detect counterfeit items. Thus, the user may use the application to determine whether the handbag is an authentic handbag or a counterfeit handbag.

As shown in FIG. 1, and based on instructions from the application, the user may use the user device to capture one or more types of information relating to the handbag. For example, the user may use the user device to capture an image of a logo of the handbag, a sound of a zipper of the handbag, and/or an image of a material of the handbag. The one or more types of information relating to the characteristics of the handbag (e.g., the image of the logo, the sound of the zipper of the handbag, and/or the image of the material) may be compared to information relating to corresponding characteristics of an authentic handbag (e.g., an image of an authentic logo, a sound of an authentic zipper, and/or an image of the material of the authentic handbag) to obtain a result. As shown in FIG. 1, and based on the result, the user device may indicate, to the user, that the handbag is a counterfeit handbag (or, in the alternative, the user device may indicate to the user that the handbag is an authentic handbag).

Accordingly, systems and methods, as described herein, may enhance the user's purchasing experience by allowing the user to purchase items with confidence, knowing whether an item is a counterfeit item or an authentic item. Additionally, systems and methods, as described herein, may allow the user to negotiate the price of an item based on an indication that the item is a counterfeit item. Additionally, systems and methods, as described herein, may allow the user to take remedial measures with respect to a purchased item that the user device identifies as a counterfeit item. For example, the user may return the purchased item for a refund. Furthermore, remedial measures may be taken against counterfeiting. For example, a notification, relating the counterfeit item, may be transmitted to an entity that manufactures the authentic item (i.e., an authentic version of the counterfeit item) and/or to a law enforcement agency.

In some implementations, the system may request permission, from the user, to collect information regarding the user (e.g., a geographical location of the user, a current date and/or a current time associated with purchasing the item, etc.). For example, the system may collect the information regarding the user only if the user opts in to the information collection process—thereby granting the system permission to collect information regarding the user. In contrast to the opt-in process described above, in an opt-out process, the system would collect the information regarding the user unless the user has specifically requested that the information regarding the user not be collected.

FIG. 2 is a diagram of an example environment 200 in which systems and/or methods described herein may be implemented. Environment 200 may include a user device 210, an server 220, and a network 230.

User device 210 may include one or more devices that are capable of detecting a counterfeit item. For example, user device 210 may include a personal digital assistant (PDA) (e.g., that include a radio telephone, a pager, Internet/intranet access, etc.), a tablet computer, a smart phone, a laptop, a gaming device, and/or a personal computer. In some implementations, user device 210 may include counterfeit detection application 215. For example, user device 210 may obtain counterfeit detection application 215 or may be preloaded with counterfeit detection application 215. User device 210 may be configured, using counterfeit detection application 215, to determine whether an item is a counterfeit item or an authentic item.

Server 220 may include one or more server devices. In some implementations, server 220 may receive, from user device 210, information relating to items and analyze the information to determine whether the items are counterfeit items.

Network 230 may include any type of network or a combination of networks. For example, network 260 may include a local area network (LAN), a wireless LAN (WLAN), a wide area network (WAN) (e.g., the Internet), a metropolitan area network (MAN), an ad hoc network, a telephone network (e.g., a Public Switched Telephone Network (PSTN), a cellular network, or a voice-over-IP (VoIP) network), a fiber optic network, or a combination of networks.

The quantity of devices and/or networks, illustrated in FIG. 2, is provided for explanatory purposes only. In practice, there may be additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

FIG. 3 is a diagram of example components of a device 300. Device 300 may correspond to user device 210 and/or server 220. Additionally, or alternatively, each of user device 210 and/or server 220 may include one or more devices 300 and/or one or more components of device 300. As illustrated in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing logic (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a camera, a microphone, a switch, etc.). Output component 350 may include a component that outputs information from device 300 (e.g., a display, an audio speaker, one or more light-emitting diodes (“LEDs”), etc.).

Communication interface 360 may include a transceiver-like component, such as a transceiver and/or a separate receiver and transmitter that enables device 300 to communicate with other devices, such as via a wired connection, a wireless connection, or a combination of wired and wireless connections. For example, a communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

FIG. 4 is an example data structure 400 that stores information that may be used to determine whether an item is a counterfeit item or an authentic item. In some implementations, all or a portion of the information, stored in data structure 400, may be received from entities that manufacture authentic items. In some implementations, server 220 may store some or all of data structure 400. In some implementations, user device 210 may store some or all of data structure 400. In some implementations, data structure 400 may be stored in memory, associated with another device or a group of devices, separate from, or in combination, with memory associated with user device 210 and/or server 220.

As shown in FIG. 4, data structure 400 may include a group of fields, such as, for example, manufacturer identification field 405, item type field 410, item identification field 415, counterfeit detection instruction field 420, image file identification field 425, audio file identification field 430, video file identification field 435, and miscellaneous information field 440.

Manufacturer identification field 405 may store information that uniquely identifies an entity that manufactures an authentic item. The information that uniquely identifies the entity may include a name of the entity, a logo of the entity, information identifying location(s) (e.g., an address) of the entity, contact information associated with the entity, and/or other information that uniquely identifies the entity.

Item type field 410 may store information that identifies a type of an authentic item. For example, item type field 410 may store information identifying an authentic item as a handbag, a pair of shoes, a piece of jewelry (e.g., a watch), an article of clothing (e.g., a pair of jeans), a sporting good (e.g., a golf), a piece of luggage, and/or the like.

Item identification field 415 may store information that uniquely identifies an authentic item. The information that uniquely identifies the authentic item may include information identifying a model of the authentic item, a serial number of the authentic item, a stock-keeping unit (SKU) number of the authentic item, information identifying a barcode of the authentic item (e.g., Universal Product Code (UPC)), and/or other information that uniquely identifies the authentic item. Additionally, or alternatively, the information that uniquely identifies the authentic item may include information identifying a color of the authentic item, information identifying a size of the authentic item, information identifying an age and/or a gender relating to the authentic item, etc.

Counterfeit detection instruction field 420 may store information that identifies a set of instructions to guide a user in capturing (using user device 210 for example) information used in determining whether an item is a counterfeit item or an authentic item. For example, the set of instructions may include an instruction to capture one or more images of one or more portions of the item (including how to locate the one or more portions), an instruction to capture one or more sounds of one or more portions of the item (including how to locate the one or more portions), an instruction to capture a video footage of one or more portions of the item, and/or the like. In some implementations, the set of instructions may be provided in a variety of formats including a text format, an image format, and/or a video format. For example, the set of instructions may provided as text. Additionally, or alternatively, the set of instructions may be provided as images that include one or more portions of the item to be captured and a manner in which user device 210 may be used to capture images, sounds, and/or other information relating to the one or more portions of the item, a location of the one or more portions of the item, etc. Additionally, or alternatively, the set of instructions may be provided as videos that include one or more portions of the item to be captured, and a manner in which user device 210 may be used to capture images, sounds, and/or information relating to the one or more portions of the item, a location of the one or more portions of the item, etc.

In some implementations, the set of instructions for an item may be based on the type of the item. For example, some or all instructions of the set of instructions for an item of one type may be different than some or all instructions of the set of instructions for an item of a different type. For example, the set of instructions relating to determining whether a handbag is authentic may include an instruction to capture an image of a logo of the handbag, an instruction to capture a sound of a zipper of the handbag, an instruction to capture a 360 degree video footage of an inside portion of the handbag, etc. In contrast, the set of instructions relating to determining whether a piece of jewelry (e.g., a wristwatch) is authentic may include, for example, an instruction to capture an image of a dial of the wristwatch, an instruction to capture an image of a bezel of the wrist watch, an instruction to capture an image of the watchband of the wristwatch, an instruction to capture an image of the crown of the wristwatch, etc.

In some implementations, one or more instructions of the set of instructions for a particular item may be similar to one or more instructions of the set of instructions for another item. In some implementations, an order of the set of instructions, with respect to an order of capturing the different types of information for an item, may be based on the type of the item. For example, the set of instructions relating to determining whether a handbag is authentic may include an instruction to capture an image of a logo of the handbag, an instruction to capture a sound of a zipper of the handbag, an instruction to capture a video footage of an inside portion of the handbag, etc. In contrast, the set of instructions relating to determining whether pair of jeans is authentic may include an instruction to capture a sound of a zipper of the pair of jeans, an instruction to capture a sound of a material of the pair of jeans, an instruction to capture an image of a logo of the pair of jeans, etc.

In some implementations, counterfeit detection instruction field 420 may also store information that identifies weights associated with results of performing different types of analyses to determine whether the item is a counterfeit item or an authentic item.

Image file identification field 425 may store information relating to one or more images of one or more portions of an authentic item. For example, with respect to an authentic handbag, the one or more images may include an image of a logo of the authentic handbag, an image of a zipper of the authentic handbag, an image of a pattern of material (e.g., leather) of the authentic handbag, etc. Image file identification field 425 may store the one or more images and/or one or more links to the one or more images. In some implementations, image file identification field 425 may store an indication that an analysis that is based on images is to be performed to determine whether an item is a counterfeit item or an authentic item.

Audio file identification field 430 may store information relating to sounds associated with one or more portions of an authentic item. For example, with respect to an authentic handbag, the one or more sounds may include a sound of a zipper of the authentic handbag (e.g., a sound of opening and/or closing the zipper), a sound of one or more buttons of the authentic handbag (e.g., a sound of tapping the button), a sound of scratching a material of the authentic handbag, a sound of texture of the material of the authentic handbag and/or the like. Audio file identification field 430 may store the one or more sounds and/or one or more links to the one or more sounds. In some implementations, image file identification field 425 may store an indication that an analysis that is based on sounds is to be performed to determine whether an item is a counterfeit item or an authentic item.

Video file identification field 430 may store information relating to video files capturing one or more portions of an authentic item. For example, with respect to an authentic handbag, the one or more video files may include a 360 degree video of the outside portion of the authentic handbag and/or a 360 degree video of the inside portion of the authentic handbag. Video file identification field 430 may store the one or more videos and/or one or more links to the one or more videos. In some implementations, image file identification field 425 may store an indication that an analysis that is based on videos is to be performed to determine whether an item is a counterfeit item or an authentic item.

Miscellaneous information field 440 may include additional information that may be used to determine whether an item is a counterfeit item or an authentic item. For example, the additional information may include information identifying a weight of an authentic item and/or one or more portions of the authentic item, information identifying a chemical composition of the authentic item and/or one or more portions of the authentic item, information identifying thermal characteristics of the authentic item and/or one or more portions of the authentic item, and/or information identifying three dimensional characteristics of the authentic item and/or one or more portions of the authentic item. Additionally, or alternatively, the additional information may include information identifying an expected location of the authentic item. For example, the information identifying the expected location of the authentic item may indicate that the authentic item is authorized to be sold at a particular location such as, for example, a particular retail store. In some implementations, the information that uniquely identifies the authentic item may be used to identify the expected location of the authentic item. For example, the barcode and/or the serial number of the authentic item may indicate that the authentic item is authorized to be sold at a particular location. In some implementations, the barcode and/or the serial number of the authentic item may be used to track a location history of the authentic item, such as from a location where the authentic item was manufactured to the expected location of the authentic item and intermediate locations.

While FIG. 4 shows example fields of data structure 400, in some implementations, data structure 400 may include different fields, additional fields, few fields, or differently arranged fields than the example fields depicted in FIG. 4.

FIG. 5 is a flowchart of an example process 500 for configuring a user device to determine whether an item is a counterfeit item or an authentic item. In some implementations, process 500 may be performed by user device 210. In some implementations, one or more blocks of process 500 may be performed by one or more devices instead of, or possibly in conjunction with, user device 210.

Process 500 may include transmitting a request for an application that may enable a user device to determine whether an item is a counterfeit item or an authentic item (block 510). For example, a user may cause user device 210 to access a user interface that provides information regarding applications that may be purchased. In some implementations, the user may cause user device 210 to access an application store, which provides information regarding applications (including counterfeit detection application 215) that may be purchased. In some implementations, the user may cause user device 210 to access the application store via, for example, a user interface (such as a browser) or in another manner. The user may then select, using user device 210, information regarding counterfeit detection application 215 from the information regarding the applications to cause user device 210 to transmit a request for counterfeit detection application 215.

Process 500 may include receiving the application (block 520). For example, user device 210 may receive counterfeit detection application 215 and store counterfeit detection application 215 in a memory associated with user device 210. In some implementations, user device 210 may receive all or a portion of the information stored in data structure 400 with counterfeit detection application 215 and store the information. In some implementations, a user, of user device 210, may establish an account associated with counterfeit detection application 215 prior to or after receiving counterfeit detection application 215.

Process 500 may include initiating a configuration of the application (block 530). For example, a user may initiate counterfeit detection application 215 and identify, using user device 210, one or more preferences relating to determining whether an item is a counterfeit item or an authentic item. In some implementations, the user may identify the one or more preferences using one or more elements of a user interface provided by user device 210. The one or more elements may include, for example, one or more text input elements, one or more drop down menu elements, one or more checkbox elements, one or more radio button elements, and/or any other types of elements that may be used to receive information from the user.

In some implementations, the one or more preferences may include a preference of the user with respect to one or more types of authentic items, a preference of the user with respect to one or more manufacturers of authentic items, etc.

In some implementations, the one or more preferences may include a preference of the user with respect to one or more types of analyses to be performed to determine whether the item is a counterfeit item or an authentic item.

For example, the user may have one or more preferences with respect to analyzing images of one or more portions of the item to determine whether the item is a counterfeit item or an authentic item. Therefore, the user may identify, using user device 210, information identifying a type of analysis to be performed as an analysis that is based on images. Additionally, or alternatively, the user may have one or more preferences with respect to analyzing sounds of one or more portions of the item to perform to determine whether the item is a counterfeit item or an authentic item. Therefore, the user may identify, using user device 210, information identifying a type of analysis to be performed as an analysis that is based on sounds.

Additionally, or alternatively, the user may have one or more preferences with respect to analyzing videos of one or more portions of the item to perform to determine whether the item is a counterfeit item or an authentic item. Therefore, the user may identify, using user device 210, information identifying a type of analysis to be performed as an analysis that is based on videos. Additionally, or alternatively, the user may identify, using user device 210, information identifying other types of analysis to be performed including an analysis that is based on a weight of the item or one or more portions of the item, an analysis that is based on a chemical composition of the item or one or more portions of the item, an analysis that is based on information regarding thermal characteristics of the item or one or more portions of the item, an analysis that is based on information regarding three dimensional characteristics of the item or one or more portions of the item, and/or any other type of analysis that may aid in the determination of whether an item is a counterfeit item or an authentic item.

In some implementations, a type of the account, of the user, associated with counterfeit detection application 215 may determine the quantity of preferences that the user is able to identify. For example, counterfeit detection application 215 may enable the user to identify only a portion of the above preferences or identify additional preferences based on the type of the account with which the user is associated.

In some implementations, counterfeit detection application 215 may analyze information relating to user device 210 and/or a user, of user device 210, to determine the one or more preferences of the user relating to determining whether an item is a counterfeit item or an authentic item. For example, the information relating to the user device may include browsing history (information relating to the user browsing the Internet), information identifying contacts of the user and/or information identifying communications between the user and the contacts (e.g., e-mail messages, instant messages, and/or the like), documents of the user, information relating to preferences of the user, and/or the like. In some implementations, counterfeit detection application 215 may analyze the information relating to user device 210 and/or the user of user device 210 only after receiving an input, from the user, authorizing the analysis. For example, based on the information relating to user device 210 and/or the user of user device 210, counterfeit detection application 215 may identify one or more preferences of the user relating to one or more types of items including handbags, one or more manufacturers including TLB (by Tanya), one or more genders associated with items (e.g., women), etc.

Process 500 may include transmitting information identifying the one or more preferences (block 540). In some implementations, the user may cause user device 210 to transmit, to server 220, information identifying the one or more preferences relating to the user.

Process 500 may include receiving configuration information that may be used to configure the application (block 550). For example, user device 210 may receive, from server 220, configuration information that may be used to configure counterfeit detection application 215 to determine whether an item is a counterfeit item or an authentic item.

In some implementations, server 220 may obtain the configuration information, that may be used to configure counterfeit detection application 215, based on the information identifying the one or more preferences of the user. For example, the configuration information may include information that uniquely identifies one or more entities that manufacture authentic items, information that identifies one or more types of the authentic items, information that uniquely identifies the authentic items (e.g., barcodes, serial numbers, SKU numbers, and/or the like), information relating to one or more images of the authentic items and/or one or more portions of the authentic items, information relating to sounds associated with the authentic items and/or one or more portions of the authentic items, information relating to video files capturing the authentic items and/or one or more portions of the authentic items.

Additionally, or alternatively, the configuration information may include information that identifies one or more sets of instructions to guide a user in capturing (using user device 210 for example) information used in determining whether the item is a counterfeit item or an authentic item, and information identifying one or more types of analyses to be performed using the information that is captured. Additionally, or alternatively, the configuration information may include information identifying a weight of the authentic items and/or one or more portions of the authentic items, information identifying a chemical composition of the authentic items and/or one or more portions of the authentic items, information identifying thermal characteristics of the authentic items and/or one or more portions of the authentic items, and/or information identifying three dimensional characteristics of the authentic items and/or one or more portions of the authentic items.

In some implementations, the configuration information may be obtained from a data structure such as, for example, data structure 400.

In some implementations, server 220 may provide, to user device 210, the configuration information independent of receiving the information identifying the one or more preferences of the user. For example, server 220 may keep track of information identifying requests of users relating to one or more authentic items, one or more types of one or more authentic items, one or more types of information (e.g., images, sounds, videos, etc.) relating to one or more authentic items, and/or one or more types of analyses to perform to determine whether an item is a counterfeit item or an authentic item. The users may include users that are part of a social network of a user of user device 210, users within a particular geographical area of the user or user device 210, etc. In some implementations, server 220 may obtain, as the configuration information, information identifying the one or more authentic items, information identifying the one or more types of one or more authentic items, information identifying the one or more types of information relating to one or more authentic items, and/or information identifying the one or more types of analysis based on a quantity of respective requests exceeding a respective threshold, and may provide the obtained configuration information to user device 210.

Process 500 may include storing the configuration information and configuring the application (block 560). For example, a user, of user device 210, may cause user device 210 to store all or a portion of the configuration information received from server 220. Counterfeit detection application 215 may be configured based on storing all or a portion of the configuration information. In some implementations, the user may configure counterfeit detection application 215 by adjusting parameters associated with one or more components of user device 210. For example, the user may adjust light sensitivity for a camera of user device 210, adjust noise cancellation for a microphone of user device 210, etc. In some implementations, the configuration information may be stored in a data structure, such as data structure 400 described above with regard to FIG. 4.

In some implementations, server 220 may provide updates, to the configuration information, to user device 210. For example, server 220 may receive updates, to the configuration information, from one or more entities that manufacture authentic items and provide the received updates to user device 210. By way of example, a handbag manufacturer may provide image information, audio information, video information relating to a newly released handbag and/or an existing handbag. User device 210 may store the updates to the configuration information. In some implementations, server 220 may provide the updates periodically based on a preference of a user of user device 210 and/or based on a time frequency determined by server 220. In some implementations, server 220 may determine whether to provide the updates based on the type of the account associated with counterfeit detection application 215. In some implementations, the updates may be stored in a data structure, such as data structure 400 described above with regard to FIG. 4.

While a series of blocks has been described with regard to FIG. 5, the blocks and/or the order of the blocks may be modified in other implementations. Further, non-dependent blocks may be performed in parallel.

FIG. 6 is an example user interface 600 that may be used in connection with process 500 described above with respect to FIG. 5. For example, user interface 600 may be provided by user device 210 to a user, of user device 210, to enable the user to identify information (e.g., preferences) that may be used to configure counterfeit detection application 215 and enable user device 210 to determine whether an item is a counterfeit item or an authentic item.

As shown in relation to FIG. 6, user interface 600 may allow the user to identify an entity that manufactures an authentic item, identify a type of the authentic item, and identify the authentic item (e.g., barcode, serial number, SKU number, and/or the like). For example, the user may identify the entity and the type of the authentic item using a drop down menu element and identify the authentic item using a text input element.

As shown in relation to FIG. 6, user interface 600 may also allow the user identifying one or more types of analysis to perform to determine whether an item is a counterfeit item or an authentic item. For example, the user may identify the types of analysis using check boxes elements and a text input element.

Once a user has identified the preferences, user interface 600 may allow the user to select a “SUBMIT” option to store the preferences and/or submit the preferences to server 220. Server 220 may then provide, to user device 210, configuration information based on the preferences.

As shown in relation to FIG. 6, user interface 600 may also allow the user to select a “BACK” option to cause user device 210 to provide information regarding counterfeit detection application 215. As shown in relation to FIG. 6, user interface 600 may also allow the user to select a “MORE CONFIGURATION” option to enable the user to identify additional information that may be used to configure counterfeit detection application 215.

The number of elements of user interface 600 shown in FIG. 6 is provided for explanatory purposes. In practice, user interface 600 may include additional elements, fewer elements, different elements, or differently arranged elements than those shown in FIG. 6.

FIG. 7 is a flowchart of an example process 700 for determining whether an item is a counterfeit item. In some implementations, process 700 may be performed by user device 210 and/or server 220. In some implementations, one or more blocks of process 700 may be performed by one or more devices instead of, or possibly in conjunction with, user device 210 and/or server 220.

Process 700 may include initiating counterfeit detection application 215 to determine whether an item is a counterfeit item or an authentic item (block 705). For example, a user, of user device 210, may be in the process of purchasing a handbag (or may have purchased the handbag) and may decide to use counterfeit detection application 215 to determine whether the handbag is an authentic handbag or a counterfeit handbag. As such, the user of user device 210 may select information identifying counterfeit detection application 215 (e.g., an icon of counterfeit detection application 215) on a user interface provided by user device 210. Selection of the information identifying counterfeit detection application 215 may cause user device 210 to initiate counterfeit detection application 215.

Process 700 may include identifying information relating to the item (block 710). For example, a user may identify, using user device 210, different types of information relating to the item as part of a request to determine whether an item is a counterfeit item or an authentic item. In some implementations, counterfeit detection application 215 may cause user device 210 to provide a user interface that may allow the user to identify the different types of information relating to the item. For example, the different types of information relating to the item may include information identifying a type of the item, information identifying an entity that manufactures the item, information that uniquely identifies the item (e.g., barcodes, serial numbers, SKU numbers, and/or the like), etc. In some implementations, the user may additionally identify one or more types of analyses to be performed to determine whether the item is a counterfeit item or an authentic item.

Process 700 may include transmitting the information relating to the item (block 715). For example, user device 210 may transmit the different types of information relating to the item to server 220, as part of a request to determine whether the item is a counterfeit item or an authentic item. In some implementations, user device 210 may additionally transmit, to server 220, information identifying the one or more types of analyses to be performed to determine whether the item is a counterfeit item or an authentic item.

Process 700 may include receiving the information relating to the item (block 720). For example, server 220 may receive, from user device 210, the different types of information relating to the item. In some implementations, server 220 may additionally receive, from user device 210, the information identifying the one or more types of analyses to be performed to determine whether the item is a counterfeit item or an authentic item.

Process 700 may include obtaining a set of instructions for determining whether the item is a counterfeit item or an authentic item (block 725). For example, server 220 may obtain, from a memory (e.g., data structure 400), the set of instructions based on the different types of information relating to the item.

In some implementations, server 220 may obtain the set of instructions by causing a search to be performed on data structure 400 using a search query that includes the information identifying the type of the item, the information identifying the entity that manufactures the item, and/or the information that uniquely identifies the item (e.g., barcodes, serial numbers, SKU numbers, and/or the like). In some implementations, the search query may also include the information identifying the one or more types of analyses to be performed to determine whether the item is a counterfeit item or an authentic item. As such, the set of instructions may correspond to instructions that match the one or more types of analyses.

In some implementations, the set of instructions may include an instruction to capture one or more images of one or more portions of the item, an instruction to capture one or more sounds of one or more portions of the item, and/or the like.

In some implementations, when user device 210 has been configured in a manner consistent with process 500, user device 210 may be preloaded with the set of instructions. Thus, in these implementations, user device 210 would not perform block 715, but would, instead, retrieve the set of instructions from a memory of user device 210.

Process 700 may include transmitting the set of instructions (block 730). For example, server 220 may transmit, to user device 210, the set of instructions (e.g., obtained from data structure 400) to guide the user in capturing information used in determining whether the item is a counterfeit item or an authentic item.

Process 700 may include receiving the set of instructions and capturing (using user device 210) the information used in determining whether the item is a counterfeit item or an authentic item (block 735). For example, counterfeit detection application 215 may instruct a user, of user device 210, to capture the information used in determining whether the item is a counterfeit item or an authentic item based on the set of instructions.

In some implementations, the set of instructions may include an instruction to capture one or more images of one or more portions of the item and counterfeit detection application 215 may instruct the user to capture the one or more images of the one or more portions of the item. For example, the set of instructions may include an instruction to capture an image of a logo of a handbag, an image of a material of the handbag, an image of stitches of the handbag, an image of the handle of the handbag, and/or one or more images of one or more other portions of the handbag. As such, counterfeit detection application 215 may instruct the user to capture, using a camera of user device 210, the image of the logo of the handbag, the image of the material of the handbag, the image of the stitches of the handbag, the image of the handle of the handbag, the one or more images of the one or more other portions of the handbag, etc.

In some implementations, the set of instructions may include an instruction to capture one or more sounds of one or more portions of the item and counterfeit detection application 215 may instruct the user to capture the one or more sounds of one or more portions of the item. For example, the set of instructions may include an instruction to capture a sound of opening and/or closing a zipper of the handbag, a sound of scratching a material of the handbag, and/or one or more sounds of one or more other portions of the handbag. As such, counterfeit detection application 215 may instruct the user to capture, using a microphone of user device 210, the sound of opening and/or closing a zipper of the handbag, the sound of the user scratching the material of the handbag, the one or more sounds of the one or more other portions of the handbag, etc.

In some implementations, the set of instructions may include an instruction to capture a video of one or more portions of the item, an instruction to capture a weight of the item and/or one more portions of the item, an instruction to capture a chemical composition of the item and/or one or more portions of the item, an instructions to capture thermal characteristics of the item and/or one or more portions of the item, etc. Accordingly, counterfeit detection application 215 may instruct the user to capture the weight of the item and/or one more portions of the item, the chemical composition of the item and/or one or more portions of the item, the thermal characteristics of the item and/or one or more portions of the item, etc. For example, the set of instructions may include an instruction to capture a weight of the handbag, a chemical composition of the handbag, and/or thermal characteristics of the handbag. As such, counterfeit detection application 215 may instruct the user to capture, using user device 210 and/or one or more devices associated with user device 210, the weight of the handbag, the chemical composition of the handbag, and/or the thermal characteristics of the handbag, etc.

Process 700 may include transmitting the captured information (block 740). For example, user device 210, using counterfeit detection application 215, may transmit, to server 220, the captured information that will be used in determining whether the item is a counterfeit item or an authentic item.

In some implementations, user device 210 may transmit, to server 220, captured information each time the information is captured. In some implementations, user device 210 may transmit, to server 220, captured information after each type of information is captured. For example, user device 210 may capture and transmit, to server 220, the one or more images of the one or more portions of the item after all of the one or more images have been captured. User device 210 may then receive a request (e.g., from server 220) to capture and transmit the one or more sounds of the one or more portions of the item to server 220. Accordingly, user device 210 may capture and transmit, to server 220, the one or more sounds of the one or more portions of the item after all of the one or more sounds have been captured. In some implementations, user device 210 may transmit, to server 220, the captured information after all the different types of information have been captured. For example, user device 210 may capture the one or more images of the one or more portions of the item and the one or more sounds of the one or more portions of the item. User device 210 may then transmit the one or more images of the one or more portions of the item and the one or more sounds of the one or more portions of the item to server 220.

Process 700 may include receiving and analyzing the captured information (block 745). For example, server 220 may receive the captured information from user device 210 and compare each piece of the captured information to a corresponding piece of information (e.g., obtained from data structure 400) to determine whether the item is a counterfeit item or an authentic item.

For example, server 220 may compare the one or more images of the one or more portions of the item, received from user device 210, to one or more images of corresponding one or more portions of the authentic item (i.e., an authentic version of the item) obtained from data structure 400. By way of example, server 220 may compare the image of the logo of the handbag to the image of the logo of the authentic handbag. Similarly, server 220 may compare the image of the material of the handbag, the image of stitches of the handbag, the image of the handle of the handbag, and/or the one or more images of the one or more other portions of the handbag to the image of the material of the authentic handbag, the image of stitches of the authentic handbag, the image of the handle of the authentic handbag, and/or the one or more images of corresponding one or more other portions of the authentic handbag.

In some implementations, server 220 may compare the one or more sounds of the one or more portions of the item, received from user device 210, to one or more sounds of corresponding one or more portions of the authentic item retrieved from data structure 400. For example, server 220 may compare the sound of opening and/or closing the zipper of the handbag to the sound of opening and/or closing the zipper of the authentic handbag. Similarly, server 220 may compare the sound of scratching the material of the handbag to the sound of scratching the material of the authentic handbag.

In some implementations, server 220 may analyze different attributes of a portion of the item and corresponding attributes of a corresponding portion of the authentic item. For example, server 220 may compare a size, a brightness, a color, a shape, and/or other attributes of the logo of the handbag to a size, a brightness, a color, a shape of the logo, and/or other attributes of the authentic handbag. Similarly, server may compare a pitch, a quality, a loudness, a frequency, and/or other attributes of opening and/or closing the zipper of the handbag to a pitch, a quality, loudness, a frequency, and/or other attributes of the sound of opening and/or closing the zipper of the authentic handbag.

In some implementations, server 220 may generate results based on analyzing the different types of information relating to the item. The results may indicate a measure of a match between the different types of information relating to the item and corresponding different types of information relating to the authentic item. In some implementations, server 220 may generate a result for each piece of information relating to the item. For example, server 220 may generate a result that indicates a 97% match for an image of a logo of the handbag, a result that indicates a 95% match for a sound of the zipper of the handbag, a result of 98% match for an image of the material, a result of 99% match for an image of stitches of the handbag, etc. In some implementations, server 220 may generate a result that indicates an overall match based on the different results. For example, server 220 may generate an average of the different results. In some implementations, server 220 may generate a result for each type of analysis. For example, server 220 may generate a result of 98% for the analyses of the images of the handbag (based on the 97% match for the image of the logo of the handbag, the 98% match for the image of the material, and the 99% match for the image of stitches of the handbag) and may generate a result of 95% for the analyses of the sounds of the handbag.

In some implementations, server 220 may determine whether the item is a counterfeit item or an authentic item based on the results of the analyses with respect to one or more thresholds. Server 220 may determine that the item is a counterfeit item if the results do not meet and/or exceed one or more thresholds. For example, server 220 may determine that the handbag is a counterfeit handbag when one or more of the results do not meet and/or exceed a 95% match. In some implementations, different thresholds may be associated with different types of analyses. For example, an analysis based on images may be associated with a threshold of 98% while an analysis based on sounds may be associated with a threshold of 97%.

In some implementations, server 220 may determine whether the item is a counterfeit item or an authentic item based on weights associated with results of performing different types of analyses. In some implementations, different weights may be associated with different types of analyses. For example, a result of an analysis based on sounds may be associated with a weight that is higher than a weight associated with a result of an analysis based on images. As such, server 220 may determine that an item is a counterfeit when a result of an analysis, based on sounds of the item, does not meet an associated threshold while a result of an analysis, based on images of the item, exceeds an associated threshold. In some implementations, the different types of analyses may be performed in an order that is based on respective ones of the weights.

In some implementations, the weights may be based on one or more factors that include the type of the authentic item, an entity that manufactures the authentic item, etc. For example, with respect to a manufacturer TLB (by Tanya), a result of an analysis based on images may be associated with a weight that is higher than a weight associated with a result of an analysis based on sounds. Additionally, or alternatively, a result of an analysis based on images, for a handbag by TLB, may be associated with a weight that is higher than a weight associated with a result of an analysis based on images for a handbag by another manufacturer.

In some implementations, server 220 may receive a type of information relating to the item, analyze the type of information relating to the item to obtain a result, and request another type of information relating to the item for additional analysis based on the result of analyzing the type of information relating to the item. For example, server 220 may receive one or more images of one or more portions of the handbag, analyze the one or more images of the one or more portions of the handbag. Server 220 may determine that additional information relating to the item is needed to determine whether the item is a counterfeit item or an authentic item based on a result of analyzing the one or more images of the one or more portions of the handbag, and request the additional information. For example, server 220 may determine that additional information relating to the item is needed when a result of analyzing the one or more images is close to but does not meet the associated threshold. The additional information may include other types of information relating to the item such as, for example, one or more sounds of one or more portions of the handbag, a barcode of the item, a serial number of the item, etc.

Process 700 may include transmitting information indicating whether the item is a counterfeit item or an authentic item (block 750). For example, server 220 may transmit, to user device 210, an indication of whether the item is a counterfeit item or an authentic item, one or more results of performing one or more of the different types of analyses, one or more thresholds associated with the different types of analyses, etc.

Process 700 may include providing the information indicating whether the item is a counterfeit item or an authentic item (block 755). For example, user device 210 may provide a user interface that indicates that the handbag is a counterfeit handbag or an authentic handbag. Additionally, or alternatively, the user interface may indicate additional information to enable a user to understand the process for determining whether the item is a counterfeit item or an authentic item. The additional information may include one or more results of performing one or more of the different types of analyses of different types of information relating to the handbag, one or more thresholds associated with the different types of analyses, etc. In some implementations, the additional information may be provided based on a request from a user of user device 210 for additional information regarding the determination.

In some implementations, a user of user device 210 may request that one or more additional types of analyses be performed. For example, although user device 210 may indicate that the handbag is an authentic handbag based on results of analyses of images and sounds of the handbag (e.g., 98.5% match for images and 98.9% match for the sounds), the user may request that an analysis of a barcode of the handbag and/or a serial number of the handbag be performed (e.g., to increase the measure of the matches). As such, the user may capture the barcode of the handbag and/or the serial number of the handbag, using user device 210, and may cause user device 210 to transmit the barcode of the handbag and/or the serial number of the handbag to server 220 for analysis. User device 210 may also submit information identifying a current location of user device 210. Server 220 may analyze the barcode of the handbag and/or the serial number of the handbag in a manner similar to the analyses described above. Server 220 may transmit, to user device 210, information confirming that the handbag is an authentic handbag or information indicating that the handbag is a counterfeit handbag based on a result of the analyses and/or weights associated with the analyses.

In some implementations, server 220 may identify, based on the barcode of the handbag and/or the serial number of the handbag, information identifying an expected location of the authentic item. Server 220 may compare the information identifying the expected location of the authentic item with the information identifying the current location of user device 210 and transmit, to user device 210, information confirming that the handbag is an authentic handbag or information indicating that the handbag is a counterfeit handbag, based on the comparison. For example, server 220 may transmit information indicating that the handbag is a counterfeit handbag when the expected location does match the current location (e.g., geographical location) of user device 210. Additionally, or alternatively, server 220 may transmit the information identifying the expected location to user device 210.

Process 700 may include performing actions when the item is a counterfeit item (block 760). For example, counterfeit detection application 215 may cause user device 210 to request information from a user of user device 210 when the item is a counterfeit item. The information may include information identifying a location (e.g., geographical location, zip code, etc.) of the counterfeit item, a quantity of counterfeit items (similar to the counterfeit item) at the location, information identifying a time period (e.g., a time, a date, a month, a year, etc.) during which the user was in the process of purchasing the counterfeit item, a price of the counterfeit item, information identifying a vendor of the counterfeit, information identifying one or more other locations associated with the vendor, information identifying other potential counterfeit items manufactured by an entity that manufactures the authentic item (e.g., a quantity of the other potential counterfeit items, types of the other potential counterfeit items, colors of the other potential counterfeit items, etc.), and/or the like. In some implementations, with an authorization from the user, counterfeit detection application 215 may cause user device 210 to capture a portion of the information. For example, counterfeit detection application 215 may cause user device 210 to capture the information identifying the location and the information identifying the time period.

In some implementations, user device 210 may receive the information, from the user, and transmit the information to server 220. In some implementations, server 220 may store the information, received from the user, along with similar information for other counterfeit items corresponding authentic items manufactured by one or more entities. For example, server 220 may store, for each entity, the captured information analyzed by server 220 (for example in block 745), information identifying one or more types of counterfeit items corresponding to authentic items manufactured by the entity, information identifying one or more locations of the counterfeit items, information identifying a quantity of the counterfeit items (e.g., a total quantity, a quantity per location, etc.), information identifying one or more vendors of the counterfeit items, the types of information (relating to the counterfeit items) that were analyzed by counterfeit detection application 215, results of the different types of analyses, and/or the like.

In some implementations, server 220 may also transmit all or one or more portions of the information to the entity, a law enforcement agency, and/or other users (e.g., users that are part of a social network of a user of user device 210, users within a particular geographical area of the user or user device 210, users that have used counterfeit detection application 215 with respect to similar items, etc.). Additionally, or alternatively, counterfeit detection application 215 may cause user device 210 to transmit all or one or more portions of the information to the entity, the law enforcement agency, and/or the other users. Additionally, or alternatively, server 220 may transmit an indication that server 220 will be tracking similar information, at additional locations, for the counterfeit items or other counterfeit items corresponding to authentic items manufactured by the entity.

The information may enable the entity to identify one or more types of authentic items that are most counterfeited, one or more locations that sell counterfeit items, differences or similarities between one or more portions of the counterfeit items and corresponding one or more portions of the authentic items, etc. Accordingly, the entity may adjust the manufacturing of the authentic items in order to further differentiate the authentic items from the counterfeit items. Additionally, or alternatively, the entity may adjust the price of the authentic item.

In some implementations, the entity may update the information that is used to determine whether an item is a counterfeit item or an authentic item based on adjusting the manufacturing of the authentic item. For example, the entity may update data structure 400 with one or more new images files of one or more portions of the authentic item, one or more new sound files of the one or more portions of the authentic item, one or more new set of instructions for the authentic item, a new barcode of the authentic item, a new serial number of the authentic item, etc.

In some implementations, the information may enable the law enforcement to travel to the one or more locations and cause the one or more vendors to cease selling the counterfeit items. In some implementations, the information may alert the other users regarding the possibility that counterfeit items are sold at the locations and/or by the vendors.

In some implementations, when user device 210 has been configured in a manner consistent with process 500, user device 210 may be preloaded with the set of instructions (including the indications of the different types of analyses) and information relating to characteristics of an authentic item (e.g., images of one or more portions of the authentic item, sounds of one or more portions of the authentic item, videos of one or more portions of the authentic item, a weight of the authentic item, etc). Thus, in these implementations, user device 210 would not perform blocks 715 and 740, but would, instead, retrieve, from a memory of user device 210, the appropriate information that may aid in the determination of whether an item is a counterfeit item or an authentic item and would perform the different types of analyses to determine whether the item is a counterfeit item or an authentic item. Moreover, user device 210 may perform the analysis of the captured information in these implementations.

While a series of blocks has been described with regard to FIG. 7, the blocks and/or the order of the blocks may be modified in other implementations. Further, non-dependent blocks may be performed in parallel.

FIGS. 8A-8H are diagrams of an example 800 of process 700 described above with respect to FIG. 7. In example 800, assume a user is the process of purchasing a TLB handbag by Tanya. Further assume the user has initiated counterfeit detection application 215 to determine whether the handbag is an authentic handbag or a counterfeit handbag.

As shown in relation to FIG. 8A, counterfeit detection application 215 may cause user device 210 to provide a user interface that may allow the user to identify an entity that manufactures an item, identify a type of the item, identify the item (e.g., barcode, serial number, SKU number, and/or the like), etc. For example, as shown in relation to FIG. 8A, the user has identified an entity that manufactures a handbag as TLB by Tanya and identified the type of the item as a handbag using drop down menu elements. Once the user has identified the entity and the type of the handbag, the user interface may allow the user to select a “SUBMIT” option to transmit the information identifying the entity and the type of the handbag to server 220. Server 220 may obtain instructions to guide the user in capturing, using user device 210, information that may be used in determining whether the handbag is a counterfeit handbag or an authentic handbag based on the information identifying the entity and the type of the handbag and may transmit the instructions to user device 210.

Assume that the instructions include a first instruction for capturing a picture of a logo of the handbag, a second instruction for capturing a picture of a material or a pattern of the material of the handbag, and a third instruction for capturing a sound of opening and/or closing a zipper of the handbag. As shown in relation to FIG. 8B, counterfeit detection application 215 may cause user device 210 to provide a user interface that provides the first instruction, of the instructions received server 220, to the user. As shown, the first instruction instructs the user to capture a picture of a logo of the handbag. The user may capture, using user device 210, a picture of the logo of the handbag by selecting the camera icon of the user interface and may select a “NEXT” option to obtain the second instruction of the instructions received from server 220. Selection of the “NEXT” option may also cause user device 210 to transmit the picture of the logo of the handbag to server 220 for analysis.

As shown in relation to FIG. 8C, counterfeit detection application 215 may cause user device 210 to provide a user interface that provides the second instruction, of the instructions received from server 220, to the user (for example, after the user has selected the “NEXT” option after the first instruction). As shown, the second instruction instructs the user to capture a picture of a material or a pattern of the material of the handbag. The user may capture, using user device 210, a picture of the material or the pattern of the material of the handbag by selecting the camera icon of the user interface and may select a “NEXT” option to obtain the third instruction of the instructions received from server 220. Selection of the “NEXT” option may also cause user device 210 transmit the picture of the material or the pattern of the material of the handbag to server 220 for analysis.

As shown in relation to FIG. 8D, counterfeit detection application 215 may cause user device 210 to provide a user interface that provides the third instruction, of the instructions received from server 220, to the user (for example, after the user has selected the “NEXT” option after the second instruction). As shown, the third instruction instructs the user to capture a sound of opening and/or closing a zipper of the handbag. The user may select the “TURN MICROPHONE ON” option, capture a sound of opening and/or closing the zipper of the handbag (e.g., using a microphone of user device 210), and select the “TURN MICROPHONE OFF” option after capturing the sound. The user may then select a “SUBMIT” option to transmit the sound of opening and/or closing the zipper of the handbag to server 220 for analysis.

Server 220 may analyze, as described herein, the picture of the logo of the handbag, the picture of the material or the pattern of the material of the handbag, and/or the sound of opening and/or closing the zipper of the handbag to determine whether the handbag is a counterfeit handbag or an authentic handbag. For example, as shown in relation to FIG. 8E, server 220 may compare the sound of opening and/or closing the zipper of the handbag to the sound of opening and/or closing the zipper of a corresponding authentic handbag as part of analyzing the sound of opening and/or closing the zipper of the handbag. Because the sound of opening and/or closing the zipper of the handbag does not match the sound of opening and/or closing the zipper of the corresponding authentic handbag, server 220 may indicate that the handbag is a counterfeit handbag.

Server 220 may transmit, to user device 210, information indicating that the handbag is a counterfeit handbag and, as shown in relation to FIG. 8F, counterfeit detection application 215 may cause user device 210 to provide a user interface that indicates to the user that the handbag is a counterfeit handbag. As shown in relation to FIG. 8F, the user interface may also provide information requesting information regarding the counterfeit handbag. For example, the user interface may provide a link to a document (e.g., a web page) that the user may use to submit the information regarding the counterfeit handbag.

The user may select the link and, as shown in relation to FIG. 8G, counterfeit detection application 215 may cause user device 210 to provide a user interface that may allow the user to enter information regarding the counterfeit handbag. As shown in relation to FIG. 8G, the user may enter, as part of the information regarding the counterfeit handbag, information identifying a location of the counterfeit item, information identifying a current date and a current time during which the user was in the process of purchasing the counterfeit item, and information identifying a vendor of the counterfeit. Additionally, the user may enter a quantity of the counterfeit items at the location, a price of the counterfeit item, information relating to the individual selling the counterfeit item, information identifying one or more other locations associated with the vendor, information identifying other potential counterfeit items manufactured by an entity that manufactures the authentic item, and/or the like.

As shown in relation to FIG. 8H, counterfeit detection application 215 may cause user device 210 to transmit all or a portion of the information regarding the counterfeit handbag to server 220. Server 220 may then transmit the information to an entity that manufactures the authentic item, a law enforcement agency, and/or other users (e.g., users that are part of a social network of the user, users within a particular geographical area of the user or user device 210, users that have used counterfeit detection application 215 with respect to handbags by a same manufacturer, etc.).

The foregoing disclosure provides illustration and description, but is not intended to be exhaustive or to limit the embodiments to the precise form disclosed. Modifications and variations are possible in light of the above disclosure or may be acquired from practice of the embodiments.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device comprising:
a memory to store instructions;
one or more processors to execute the instructions to:
receive a request, from a user, to determine whether an item is a counterfeit item,
the request including:
information identifying a type of the item, and
information identifying an entity that manufactures an authentic item that corresponds to the item,
perform, based on receiving the request, a comparison of at least one of:
one or more images of one or more first portions of the item to one or more images of corresponding one or more first portions of the authentic item that corresponds to the item, or
one or more sounds of one or more second portions of the item to one or more sounds of corresponding one or more second portions of the authentic item,
determine whether the item is a counterfeit item based on performing the comparison, and
provide, to the user and based on determining whether the item is a counterfeit item, information indicating whether the item is a counterfeit item.

2. The device of claim 1, where the one or more processors are further to:
determine that the item is a counterfeit item, and
transmit, to a law enforcement agency, information indicating that a counterfeit item has been identified based on determining that the item is a counterfeit item.

3. The device of claim 2, where the one or more processors are further to:
obtain a location of the item based on determining that the item is a counterfeit item,
where the information indicating that a counterfeit item has been identified includes information identifying the location of the item.

4. The device of claim 1, where the one or more processors are further to:
determine that the item is a counterfeit item, and
transmit, to the entity, information indicating that a counterfeit item, corresponding to the authentic item, has been identified based on determining that the item is a counterfeit item.

5. The device of claim 4, where the information indicating that a counterfeit item, corresponding to the authentic item, has been identified includes at least one of:
the one or more images of the one or more first portions of the item,
the one or more sounds of the one or more second portions of the item, or
information identifying a location of the item.

6. The device of claim 1, where the one or more processors are further to:
obtain, using the information identifying the type of the item and the information identifying the entity, information instructing the user to capture at least one of:
the one or more images of the one or more first portions of the item, or
the one or more sounds of the one or more second portions of the item, and
provide, to the user, the information instructing the user to capture the at least one of:
the one or more images of the one or more first portions of the item, or
the one or more sounds of the one or more second portions of the item.

7. The device of claim 1, where the one or more processors are further to:
store in the memory:
the one or more images of the corresponding one or more first portions of the authentic item, and
the one or more sounds of the corresponding one or more second portions of the authentic item,
receive one or more updates to the one or more images of the corresponding one or more first portions of the authentic item and the one or more sounds of the corresponding one or more second portions of the authentic item, and
update the one or more images of the corresponding one or more first portions of the authentic item and the one or more sounds of the corresponding one or more second portions of the authentic item based on receiving the one or more updates.

8. The device of claim 1, where the device includes:
a personal digital assistant,
a tablet computer,
a smart phone,
a laptop,
a gaming device, or
a personal computer.

9. A method comprising:
receiving, by one or more devices, a request to determine whether a particular item is a counterfeit item or an authentic item,
the request including information identifying the particular item;
comparing, by the one or more devices and based on receiving the request, one or more characteristics of the particular item to corresponding one or more characteristics of an authentic version of the particular item;
determining, by the one or more devices, whether the particular item is a counterfeit item based on comparing the one or more characteristics of the particular item to the corresponding one or more characteristics of the authentic version of the particular item; and
providing, by the one or more devices, a result of determining whether the particular item is a counterfeit item or an authentic item.

10. The method of claim 9, where the request is received from a user associated with the one or more devices, and
where providing the result includes:
providing, to the user, information indicating that the particular item is a counterfeit item when the particular item is a counterfeit item; and
providing, to the user, information indicating that the particular item is not a counterfeit item when the particular item is not a counterfeit item.

11. The method of claim 9, where the request is received from a user associated with the one or more devices,
the method further comprising:
determining that the particular item is a counterfeit item;
prompting the user, based on determining that the particular item is a counterfeit item, to provide information regarding the particular item; and
receiving, from the user and based on prompting the user, the information regarding the particular item,
where the received information includes one or more of:
information identifying a geographical location of the particular item,
information identifying a vendor of the particular item, or
information identifying a date at which the particular item was being purchased or a date associated with the request to determine whether the particular item is a counterfeit item or an authentic item.

12. The method of claim 11, further comprising:
transmitting, to the entity that manufactures the authentic version of the item, information indicating that a counterfeit item, corresponding to the authentic version of the item, has been identified based on determining that the particular item is a counterfeit item,
where the information indicating that a counterfeit item, corresponding to the authentic item, has been identified includes the one or more of:
the information identifying the geographical location of the particular item,
the information identifying the vendor of the particular item, or
the information identifying the current time and the current date.

13. The method of claim 11, where the information indicating that a counterfeit item, corresponding to the authentic version of the item, has been identified further includes information identifying the one or more characteristics of the particular item.

14. The method of claim 9, further comprising:
determining that the particular item is a counterfeit item; and
transmitting, to a law enforcement agency, information indication that a counterfeit item, corresponding to the authentic version of the item, has been identified based on determining that the particular item is a counterfeit item,
where the information indicating that a counterfeit item, corresponding to the authentic version of the item, has been identified includes one or more of:
information identifying a geographical location of the particular item, or
information identifying a vendor of the particular item.

15. The method of claim 9, where the one or more characteristics of the particular item include at least one of:
an image of a first portion of the particular item,
a sound of a second portion of the particular item,
a weight of a third portion of the particular item,
a chemical composition of a fourth portion of the particular item,
thermal characteristics of a fifth portion of the particular item, or
three dimensional characteristics of a sixth portion of the particular item, and
where comparing the one or more characteristics of the particular item to corresponding the one or more characteristics of the authentic version of the particular item includes at least one of:
comparing the image of the first portion of the particular item to the image of a corresponding portion of the authentic version of the particular item,
comparing the sound of the second portion of the item to the sound of a corresponding portion of the authentic version of the particular item,
comparing the weight of the third portion of the particular item to a weight of a corresponding portion of the authentic version of the particular item,
comparing the chemical composition of the fourth portion of the particular item to a chemical composition of a corresponding portion of the authentic version of the particular item,
comparing the thermal characteristics of the fifth portion of the particular item to thermal characteristics of a corresponding portion of the authentic version of the particular item, or
comparing the three dimensional characteristics of the sixth portion of the particular item to three dimensional characteristics of a corresponding portion of the authentic version of the particular item.

16. The method of claim 15, where determining whether the particular item is a counterfeit item includes:
determining that the particular item is a counterfeit item when at least one of:
a result of comparing the image of the first portion of the particular item to the image of the corresponding first portion of the authentic version of the particular item does not meet a first threshold,
a result of comparing the sound of the second portion of the item to the sound of the corresponding second portion of the authentic version of the particular item does not meet a second threshold,
a result of comparing the weight of the third portion of the particular item to a weight of a corresponding portion of the authentic version of the particular item does not meet a third threshold,
a result of comparing the chemical composition of the fourth portion of the particular item to a chemical composition of a corresponding portion of the authentic version of the particular item does not meet a fourth threshold,
a result of comparing the thermal characteristics of the fifth portion of the particular item to thermal characteristics of a corresponding portion of the authentic version of the particular item does not meet a fifth threshold, or
a result of comparing the three dimensional characteristics of the sixth portion of the particular item to three dimensional characteristics of a corresponding portion of the authentic version of the particular item does not meet a sixth threshold.

17. A computer-readable medium storing instructions, the instructions comprising:
a plurality of instructions which, when executed by one or more devices, cause the one or more devices to:
receive a request, from a user, to determine whether an item is a counterfeit item,
the request including information identifying the item;
perform, based on receiving the request, a comparison of a sound of a portion of the item to a sound of a corresponding portion of an authentic item that corresponds to the item;
determine whether the item is a counterfeit item based on performing the comparison; and
provide, to the user and based on determining whether the item is a counterfeit item, information indicating whether the item is a counterfeit item.

18. The computer-readable medium of claim 17, where the information identifying the item includes at least one of:
information identifying a type of the item, or
information identifying an entity that manufactures the item,
the instructions further comprising:
instructions which, when executed by one or more devices, cause the one or more devices to obtain the sound of the corresponding portion of the authentic item using the at least one of the information identifying the type of the item or the information identifying the entity that manufactures the item.

19. The computer-readable medium of claim 17, the instructions further comprising:
a plurality of instructions which, when executed by the one or more devices, cause the one or more devices to:
receive, from the user, a request to analyze at least one of a barcode or a serial number of the item after providing the information indicating whether the item is a counterfeit item;
receive, from the user, the at least one of the barcode or the serial number of the item and information identifying a geographical location of the item;
identify an expected geographical location of the authentic item based on the at least one of the barcode or the serial number of the item; and
determine that the item is a counterfeit when the expected geographical location of the authentic item does not match the geographical location of the item.

20. The computer-readable medium of claim 19, the instructions further comprising:
one or more instructions which, when executed by the one or more devices, cause the one or more devices to transmit, to an entity that manufactures the authentic item or to a law enforcement agency, information indicating that a counterfeit item, corresponding to the authentic item, has been identified based on determining that the item is a counterfeit item.
